(19) United States
(12) Patent Application Publication
(10) Pub. No.: US 2017/0295104 A1
(43) Pub. Date: Oct. 12, 2017

(54) NETWORK SELECTION FOR RELAYING OF DELAY-TOLERANT TRAFFIC

(71) Applicant: QUALCOMM Incorporated, San Diego, CA (US)

(72) Inventors: Karl Georg Hampel, New York, NY (US); Vincent Douglas Park, Budd Lake, NJ (US); Junyi Li, Chester, NJ (US)

(21) Appl. No.: 15/093,128

(22) Filed: Apr. 7, 2016

(51) Int. Cl. H04L 12/851; H04W 48/18

(52) U.S. Cl. CPC H04L 47/24; H04W 48/18; H04W 88/04

(57) ABSTRACT

Methods, systems, and devices for wireless communication are described. A user equipment (UE) may act as a relay device and receive a message from a source device. The message may include a latency indicator. The UE may identify a delay-tolerance metric associated with the message based on the latency indicator. The UE may identify, for each air interface of a set of air interfaces, a cost metric associated with transmitting the message. The UE may select an air interface from the set of air interfaces based on the delay-tolerance metric and the cost metric. The UE may transmit the message to a destination device on the selected air interface.

### BACKGROUND

The following relates generally to wireless communication, and more specifically to network selection for relaying of delay-tolerant traffic.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE). A wireless network may also include components of a WLAN, such as a Wi-Fi (i.e., IEEE 802.11) network, and may include access points (APs) that may communicate with at least one UE or station (STA).

Other wireless devices may also be deployed and may have limited available power and also a limited means to directly connect to a wireless network, e.g., due to the costs associated with equipping such devices with the hardware and subscription costs associated with cellular communications. While WLAN (e.g., Wi-Fi) hardware and associations may be an alternative, this may also be difficult due to limited coverage areas, upkeep in linking with changing configurations and settings, etc. Another aspects of such wireless devices, e.g., wearable devices, sensor nodes, internet-of-things (IoT) devices, etc., is that they may have a limited amount of information to convey and, in many cases, that information is not necessarily time-sensitive, e.g., as compared to real-time communications.

### SUMMARY

The described techniques relate to techniques that support network selection for relaying of delay-tolerant traffic. Generally, the described techniques provide for a relay device, such as a UE for example, to receive a delay tolerant message and select an appropriate wireless network (e.g., air interface) to forward the message based on the urgency of the message and the costs associated with sending the message. For example, the UE may receive the message with a latency indicator and use the latency indicator to determine a delay-tolerance metric for the message. The latency indicator may indicate a delivery deadline, a delivery window, a priority level, a data type indication, etc., for the message. The UE may also determine a cost metric for each available air interface (e.g., for each available wireless network) associated with transmitting the message. The cost metric may be based on or indicative of a monetary cost, a data limit, an overhead limit, an existing connection aspects, etc., associated with each air interface. The UE may select an air interface for transmitting the message based on the delay-tolerance metric and the cost metric and transmit the message on the selected air interface. The UE may periodically evaluate the cost metric based on the delay-tolerance metric to select the air interface, e.g., as the delivery deadline approaches, the UE may select a more costly air interface.

A method of wireless communication is described. The method may include receiving, at a relay device, a message from a source device, the message comprising a latency indicator, identifying an delay-tolerance metric associated with the message, the delay-tolerance metric based at least in part on the latency indicator, identifying, for each air interface of a set of air interfaces, a cost metric associated with transmitting the message, selecting an air interface, from the set of air interfaces, based at least in part on the delay-tolerance metric and the cost metrics and transmitting the message to a destination device via the selected air interface.

An apparatus for wireless communication is described. The apparatus may include means for receiving, at a relay device, a message from a source device, the message comprising a latency indicator, means for identifying an delay-tolerance metric associated with the message, the delay-tolerance metric based at least in part on the latency indicator, means for identifying, for each air interface of a set of air interfaces, a cost metric associated with transmitting the message, means for selecting an air interface, from the set of air interfaces, based at least in part on the delay-tolerance metric and the cost metrics and means for transmitting the message to a destination device via the selected air interface.

A further apparatus is described. The apparatus may include a processor, memory in electronic communication with the processor, and instructions stored in the memory. The instructions may be operable to cause the processor to receive, at a relay device, a message from a source device, the message comprising a latency indicator, identify an delay-tolerance metric associated with the message, the delay-tolerance metric based at least in part on the latency indicator, identify, for each air interface of a set of air interfaces, a cost metric associated with transmitting the message, select an air interface, from the set of air interfaces, based at least in part on the delay-tolerance metric and the cost metrics and transmit the message to a destination device via the selected air interface.

A non-transitory computer readable medium for wireless communication is described. The non-transitory computer-readable medium may include instructions to cause a processor to receive, at a relay device, a message from a source device, the message comprising a latency indicator, identify an delay-tolerance metric associated with the message, the delay-tolerance metric based on the latency indicator, identify, for each air interface of a set of air interfaces, a cost metric associated with transmitting the message, select an air interface, from the set of air interfaces, based on the delay-tolerance metric and the cost metrics and transmit the message to a destination device via the selected air interface.

Some examples of the method, apparatus, or non-transitory computer-readable medium described above may further include processes, features, means, or instructions for determining the cost metric for each air interface according to a periodic schedule. Some examples of the method, apparatus, or non-transitory computer-readable medium described above may further include processes, features, means, or instructions for adjusting the periodic schedule based on the delay-tolerance metric indicating at least one of a delivery deadline associated with the message is within a predefined threshold, a remaining portion of a delivery window associated with the message is within a predefined threshold, a delivery priority associated with the message is above a threshold level, or combinations thereof.

In some examples of the method, apparatus, or non-transitory computer-readable medium described above, the delay-tolerance metric is associated with at least one of a delivery deadline associated with the message, a delivery window associated with the message, a delivery priority associated with the message, or combinations thereof. In some examples of the method, apparatus, or non-transitory computer-readable medium described above, the cost metric is associated with at least one of a monetary cost associated with transmitting the message via the air interface, a data limit associated with the air interface, a communication channel quality associated with the air interface, a current connection to the air interface, a relay device resource utilization metric associated with transmitting the message via the air interface, or combinations thereof.

In some examples of the method, apparatus, or non-transitory computer-readable medium described above, an air interface of the set of air interfaces comprises at least one of a cellular radio access technology (RAT), or a Wi-Fi RAT, or a Bluetooth RAT, or a Bluetooth low energy RAT, or a device-to-device (D2D) RAT. In some examples of the method, apparatus, or non-transitory computer-readable medium described above, transmitting the message via the selected air interface comprises: transmitting the message via a licensed radio frequency (RF) spectrum band or an unlicensed RF spectrum band.

In some examples of the method, apparatus, or non-transitory computer-readable medium described above, the source device comprises at least one of a wearable device, a sensor device, or combinations thereof. In some examples of the method, apparatus, or non-transitory computer-readable medium described above, the source device comprises at least one of an application layer associated with the relay device.

### BRIEF DESCRIPTION OF THE DRAWINGS

FIG. 1 illustrates an example of a wireless communications system that supports network selection for relaying of delay-tolerant traffic in accordance with aspects of the present disclosure;

FIG. 2 illustrates an example of a wireless communications system that supports network selection for relaying of delay-tolerant traffic in accordance with aspects of the present disclosure;

FIG. 3 illustrates an example of a process flow in a system that supports network selection for relaying of delay-tolerant traffic in accordance with aspects of the present disclosure;

FIG. 4 illustrates an example of a process flow in a system that supports network selection for relaying of delay-tolerant traffic in accordance with aspects of the present disclosure;

FIGS. 5 through 7 show block diagrams of a wireless device that supports network selection for relaying of delay-tolerant traffic in accordance with aspects of the present disclosure;

FIG. 8 illustrates a block diagram of a system including a UE that supports network selection for relaying of delay-tolerant traffic in accordance with aspects of the present disclosure; and

FIGS. 9 through 11 illustrate methods for network selection for relaying of delay-tolerant traffic in accordance with aspects of the present disclosure.

### DETAILED DESCRIPTION

Certain wireless devices (referred to as source devices) may not be equipped for communications via every available air interface. For example, the cost and/or complexity associated with a cellular air interface, such as a Long Term Evolution (LTE)/LTE-Advanced (LTE-A) network may be inappropriate for sensor devices, wearable devices, internet-of-things (IoT) devices. While a Wireless Local Area Network (WLAN) may be somewhat less costly, at least from a subscription perspective, these Wi-Fi networks typically require close proximity to the source device and/or can include complicated association overhead. The source devices may support environmental measurements, structural health monitoring, smart-city applications, health or location tracking applications, usage monitoring of various electrical devices, etc. These source devices, however, typically transmit rather small data messages (in some examples) with a low duty cycle (once per hour, day, or month). Moreover, these data messages may be associated with a high latency such that immediate delivery of the message is not a priority.

Aspects of the disclosure are initially described in the context of a wireless communication system. Aspects of the present disclosure relate to the forwarding of delay-tolerant data or messages by a user equipment (UE) to a destination device, such as a cloud or remote server. A message may be of any size, e.g., it could be a large or small data file. The message may arrive through any interface to the UE, such as a wireless device-to-device (D2D) interface or an interface between a higher protocol layer (e.g., application layer) and a forwarding layer (e.g., an internet protocol (IP) layer), for instance. The source device may therefore be an application on the UE, another UE, a sensor device, etc. The message may be delay tolerant and include a latency indicator. The UE may receive the message with the latency indicator which specifies the degree of delay tolerance for the message. The UE may select among multiple interfaces which use different air-interface technologies or which connect to different networks or network operators. The UE may select the most appropriate of these air interfaces by optimally balancing between the cost of transmitting the message, the urgency of the message, and availability of the various air interfaces. In certain aspects, the delay tolerant message may be an IoT message, which are to be sent by sensor devices to an IoT platform in the cloud referred to as data aggregator.

Thus, in some aspects, a UE may be configured as a relay device. The UE may receive a message from a source device that includes a latency indicator. The UE may use the latency indicator to identify a delay-tolerance metric associated with the message. The delay-tolerance metric may be an indication of the urgency, timeline, priority, etc., for transmitting the message. The UE may identify a cost metric for each air interface, e.g., for each air interface that the UE supports and is available for communications. The UE may use the cost metric and the delay-tolerance metric to select an air interface. The UE may transmit the message to a destination device, e.g., remote server, data aggregator, etc., on the selected air interface.

Aspects of the disclosure are further illustrated by and described with reference to apparatus diagrams, system diagrams, and flowcharts that relate to network selection for relaying of delay-tolerant traffic.

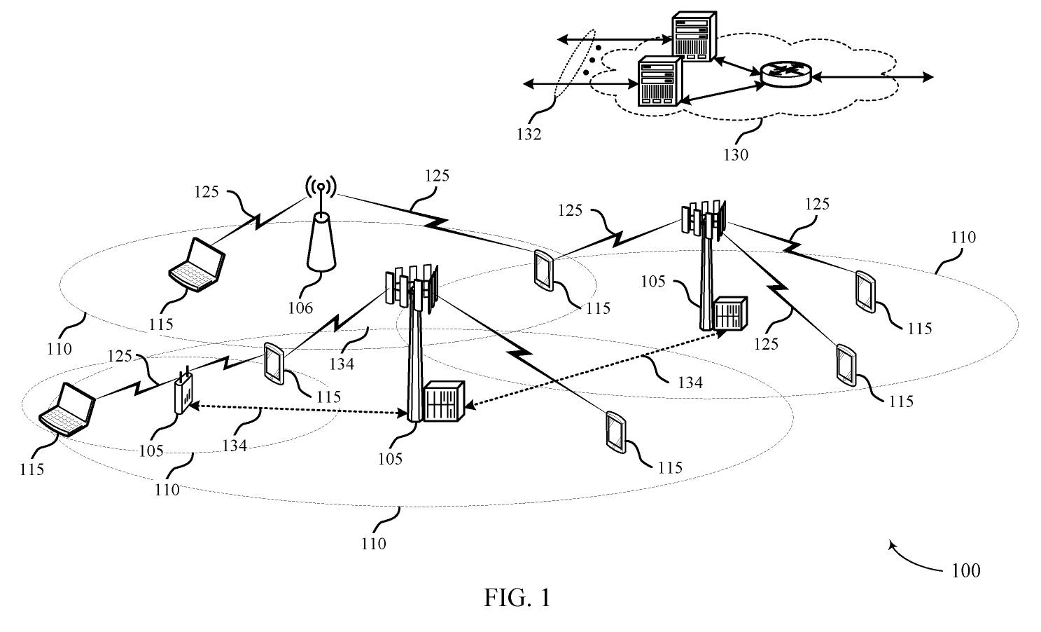

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a LTE/LTE-A network.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a relay device, a wireless device, an access terminal (AT), a handset, a user agent, a client, or like terminology. A UE 115 may also be a cellular phone, a wireless modem, a handheld device, a personal computer, a tablet, a personal electronic device, an machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

The wireless communications system 100 may also include at least one access point (AP) 106, which may communicate with UEs 115 such as mobile stations, personal digital assistant (PDAs), other handheld devices, netbooks, notebook computers, tablet computers, laptops, display devices (e.g., TVs, computer monitors, etc.), printers, etc. In some cases, the AP 106 may be a component of a WLAN, which may be a trusted WLAN associated with the WWAN of wireless communications system 100. The AP 106 and the associated UEs 115 may represent a basic service set (BSS) or an extended service set (ESS). The various UEs 115 in the network are able to communicate with one another through the AP 106. Also shown is a coverage area 110 of the AP 106, which may represent a basic service area (BSA) of the wireless communications system 100. An extended network station (not shown) associated with the wireless communications system 100 may be connected to a wired or wireless distribution system that may allow multiple APs 106 to be connected in an ESS.

Wireless communications system 100 may support operation on multiple cells or carriers, a feature which may be referred to as carrier aggregation (CA) or multi-carrier operation. A carrier may also be referred to as a component carrier (CC), a layer, or the like. The terms “carrier,” “component carrier,” and “cell” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced CCs (eCC). An enhanced component carrier (eCC) may be characterized by one or more features including: wider bandwidth, shorter symbol duration, shorter transmission time interval (TTIs), and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 Mhz, etc.) at reduced symbol durations (e.g., 16.67 μs). A TTI in eCC may consist of one or multiple symbols. In some cases, the TTI duration (that is, the number of symbols in a TTI) may be variable. In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 Mhz, etc.) at reduced symbol durations (e.g., 16.67 μs). A TTI in eCC may consist of one or multiple symbols. In some cases, the TTI duration (that is, the number of symbols in a TTI) may be variable.

Wireless communications system 100 may be a heterogeneous wireless network that supports communications using a variety of air interfaces. In some aspects, the supported air interfaces may be a set of air interfaces that are available for wireless communications. Each air interface may be associated with a different radio access technology (RAT), such as a cellular RAT, a Wi-Fi RAT, a Bluetooth (BT) RAT, a ZigBee RAT, etc. Additionally or alternatively, each air interface may be associated with a different wireless network operator, a different public land mobile network (PLMN), etc. Additionally or alternatively, each air interface may be associated with a licensed radio frequency spectrum band and/or an unlicensed radio frequency spectrum band. The UEs 115 may support communications on a variety of different air interfaces, e.g., cellular, Wi-Fi, BT, etc.

In certain aspects, UE(s) 115 may support network selection for relaying of delay tolerant traffic. For example, a UE 115 may receive a message from a source device that includes a latency indicator. The UE 115 may identify a delay-tolerance metric associated with the message based on the latency indicator. The UE 115 may also identify a cost metric for each air interface of a set of air interfaces, e.g., for each air interface available for wireless communications. The cost metric may be associated with transmitting the message via the air interface, e.g., in terms of a data cost, a financial cost, an overhead cost, etc. The UE 115 may select an air interface and transmit the message. The UE 115 may select the air interface based on the delay-tolerance metric of the message and the cost metric of the air interface. The UE 115 may determine the cost metric for each air interface according to a schedule. The schedule may be periodic or non-periodic. In one example, the schedule may be based on the urgency of delivering the message, e.g., an approaching delivery deadline, delivery window, a priority of the message, etc.

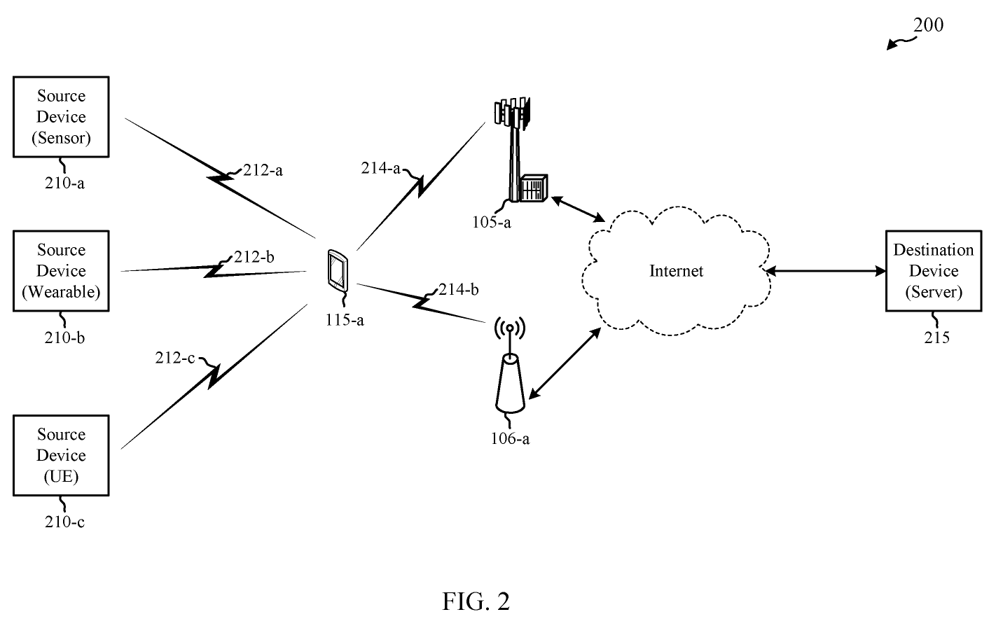

FIG. 2 illustrates an example of a wireless communications system 200 for network selection for relaying of delay-tolerant traffic. Wireless communications system 200 may include base station 105-a, an AP 106-a, and UE 115-a, which may be examples of the corresponding devices described with reference to FIG. 1. Wireless communications system 200 may also include source devices 210 and a destination device 215. Broadly, wireless communications system 200 illustrates an example where source devices 210 pass messages to UE 115-a via a short-range air interface technology that includes a message-specific latency indicator. The UE 115-a caches each message together with a latency deadline which it derives from the message's latency indicator. The UE 115-a periodically evaluates the availability of the various access opportunities and selects a specific air interface for an access network for message delivery based on the cost of data delivery and the deadline of the message.

Source devices 210 may include a variety of different devices. For example, source device 210-a may be a sensor device, such as an environmental sensor, a mechanical sensor, a health monitoring sensor, and the like. As another example, source device 210-b may be a wearable device such a smart watch, an IoT device, a fitness device, and the like. As yet another example, source device 210-c may be another UE 115. In some examples, the source device 210 may refer to an application on UE 115-a (not shown), such as a higher layer application (e.g., IP layer). Source devices 210, in some examples, may not be configured for communications on certain air interfaces, e.g., Wi-Fi and/or cellular air interfaces. For example, the monetary costs associated with hardware/subscriptions to such air interfaces may be prohibitive, e.g., cellular RATs. In other examples, the coverage areas for different air interfaces may not support communications with source devices 210, e.g., Wi-Fi RATs and/or hotspots.

Source devices 210-a through 210-c may communicate with UE 115-a via first air interface 212-a through 212-c, respectively. Each of first air interfaces 212 may be the same or different air interfaces. Examples of first air interfaces 212 may include, but are not limited to, a BT air interface, a BT Low Energy air interface, a near-field communication (NFC) air interface, a ZigBee air interface, an infrared air interface, and the like. The first air interfaces 212 may utilize licensed and/or unlicensed radio frequency spectrum bands. The first air interfaces 212 may also be examples of direct communications, such as device-to-device (D2D) air interfaces, Wi-Fi direct air interfaces, peer-to-peer (P2P) air interfaces, etc.

Source devices 210 may have message(s) (e.g., data, control information, etc.) to be relayed to a destination device 215, which may be a data aggregator, cloud server, remote server, etc. In some examples, the messages may be small data messages and/or large data messages. In some examples, the messages may have a low duty cycle in that the source devices 210 only transmits the messages once per hour, day, week, month, etc. Moreover, the messages may be delay tolerant messages. Accordingly, the source devices 210 may include a latency indicator in the messages to the UE 115-a. The latency indicator may be an information element, field, pointer, etc., that provides an indication of a timeframe for delivery of the message. The timeframe may be based on a hard delivery deadline for the message, e.g., by a certain time on a certain day. The timeframe may be based on a delivery window for the message, e.g., a period when the message can be delivered and/or is expected to be delivered. The timeframe may be based on a priority level associated with the message, e.g., high priority messages are delivered within a certain time period, low priority messages may be delivered within a longer time period, etc. The timeframe may also be based on a data type associated with the message, e.g., certain data types are more delay tolerant than other data types. The timeframe may also be based on the type of source device 210, e.g., certain sensors may support longer delay tolerances than other

Aspects of the disclosure provide for source devices 210 to use the community of existing smart devices, such as UE 115-a, to relay delay tolerant messages to the destination device 215. The density of smart devices within a given area may be considerable and, in many circumstances, the smart devices may support cellular and Wi-Fi air interface communications to provide access to the internet, such as second air interfaces 214. Such smart devices may also support communications on air interfaces operable with source devices 210, such as first air interfaces 212. Although the describes techniques generally use examples of short range air interface technologies, such as BT, ZigBee, etc., as the first air interfaces 212, it is to be understood that first air interfaces 212 may also be longer range air interface technologies, such as cellular, Wi-Fi, etc.

As the number, density, etc., of source devices 210 continue to increase, aspects of the present disclosure may support increased message relaying between the source devices 210 and the destination device 215, via smart devices such as UE 115-a. UE 115-a may, in some examples, bundle messages from multiple source devices 210 and may support bulk delivery of the messages in accordance with the present disclosure.

Thus, in some aspects UE 115-a may be a relay device that relays delay tolerant traffic from source devices 210 to a destination device 215 which may be a server, in some examples. UE 115-a may receive a message from a source device 210 via a first air interface 212. The message may be a delay tolerant message and may include a latency indicator. The UE 115-a may identify a delay-tolerance metric associated with the message based on the latency indicator. The UE 115-a may identify a cost metric for each air interface 214-a (e.g., cellular air interface via base station 105-a) and 214-b (e.g., Wi-Fi air interface via AP 106-a) of the available air interfaces associated with transmitting the message to the destination device 215.

In determining the delay-tolerance metric for the message, the UE 115-a may use the latency indicator included in the message. For example, the latency indicator may provide an indication of a timeframe for delivery of the message, e.g., delivery deadline for the message, a delivery window for the message, a priority level associated with the message, a data type associated with the message, a type of source device 210 sending the message, etc. The delay-tolerance metric may provide an indication of the urgency of sending the delay tolerant message to the destination device. The UE 115-a may store the message until an air interface is selected.

UE 115-a may leverage the delay tolerance of the message to optimize access cost and resource utilization for the message forwarding process. It is to be understood that UE 115-a may receive multiple messages from the same and/or different source devices 210 where each message may have a different latency indicator, e.g., be associated with a different delivery urgency for the respective message. The UE 115-a may support the described techniques for message forwarding that is consistent with the delivery urgency of each message.

In determining the cost metric, UE 115-a may consider cost factors such as a monetary cost associated with transmitting the message, a data limit for a particular air interface, a communications channel quality associated with an air interface, a current connection status to the air interface, a resource utilization associated with forwarding the message, etc. Thus, UE 115-a may consider the availability of access network on air interfaces, the respective RAT for each air interface, etc., when determining the cost metric. In some aspects, UE 115-a identifying the cost metric may consider a cellular air interface (e.g., such as LTE/LTE-A) may provide wide coverage areas, but may also be associated with high subscription costs. In some aspects, UE 115-a identifying the cost metric may consider a WLAN air interface (e.g., Wi-Fi air interface) may be relatively inexpensive (often having a flat-rate subscription), but may also be associated with small coverage areas.

In some aspects, UE 115-a identifying the cost metric may consider the resource cost of forwarding the message from the source device 210, e.g., battery usage of UE 115-a, processing power on UE 115-a, etc. In some aspects, UE 115-a identifying the cost metric may consider whether a layer-2 connection has been established by the UE 115-a for other reasons, e.g., for web browsing session, that are not associated with the message forwarding. When the current connection indicates that a connection is active, UE 115-a may consider the costs associated with using this layer-2 connection to also forward the message(s) to destination device 215. In this situation where the UE 115-a has an active connection, this may have less impact on the total resource consumption than establishing a separate connection for the message forwarding on a more efficient air interface.

The UE 115-a may periodically evaluate the availability of the various wireless air interfaces it supports to the network, such as second air interfaces 214, to determine the cost metric. Availability may refer, in some examples, to reception of a beacon signal with sufficient signal strength, an association level that UE 115-a shares with the network determined by processes such as network association, registration, authentication, PDN context- or bearer establishment, or ongoing traffic. In some aspects, availability may be based on more detailed channel information such as a signal-to-interference noise (SINR) ratio, for instance.

Considering such features, UE 115-a may derive a cost metric for each air interface that it supports communications on, which may include monetary costs to the UE 115-a subscriber or a third party, as well as virtual costs associated with the effort and the resources needed to obtain network connectivity to forward the messages. The monetary costs may be dependent of time and location. The cost metric may also include factors related to the present availability of resources, such as battery or processing power.

Given the metric analysis for each wireless network air interface, the current time as well as the delivery deadline for the stored messages (as indicated by the delay-tolerance metric for each message), the UE 115-a may select and use one of the air interfaces to deliver all or a subset of stored messages. All (or a portion) of the remaining messages may remain stored until the next evaluation cycle.

As one example, the UE 115-a may select an air interface based on the cost metric meeting or exceeding the delay-tolerance metric by a threshold level. For example, the delay-tolerance metric may increase as the delivery deadline approaches, as the delivery window is closing, etc., for each message. As the delay-tolerance metric increases, the costs associated with forwarding the message become less important and the UE 115-a may expend more costs to forward the message. On the contrary, as the delay-tolerance metric indicates the delivery deadline for the message is not approaching, the UE 115-a may store the message longer rather than incur additional costs for forwarding the message.

In some aspects, an evaluation cycle may include UE 115-a periodically determining the cost metric for each air interface according to a schedule. The schedule may be periodic, non-periodic, dynamically determined based on the delay-tolerance metric for each stored message(s), etc. Thus, the UE 115-a may adjust the schedule as the delivery deadline approaches, as the delivery window for the message is closing, based on the delivery priority of the message, etc.

Thus, UE 115-a may select an air interface, such as one of second air interfaces 214-a and/or 214-b using the delay-tolerance metric and the cost metric. The UE 115-may then transmit the message to destination device 215. When a cellular air interface or RAT is selected, UE 115-a may transmit the message to destination device 215 via base station 105-a which provides a connection to the internet. When a Wi-Fi air interface or RAT is selected, UE 115-a may transmit the message to destination device 215 via AP 106-a which also provides a connection to the internet.

Turning now to additional, non-limiting aspects and examples, the latency indicator in the message received by the source device 210 may represent a relative time window of message delivery (e.g., the message is to be delivered within one hour, one day, etc.). The UE 115-a may determine the deadline from this time window and the current time (e.g., the delay-tolerance metric for the message). The UE 115-a may include a margin of tolerance for connection setup, etc., associated with forwarding the message. In some aspects, the latency indicator may represent an absolute delivery time, e.g., the delivery deadline for the message. This may apply to source devices 210 that are configured to support some notion of time, e.g., have an internal clock, access a system time, etc. The UE 115-a may set the message delivery deadline to this delivery time value (e.g., the delay-tolerance metric for the message), or may subtract a tolerance margin for connection setup, etc. In some aspects, latency indicator may point to a an entry in a classification table, which may contain concrete time windows such as 5 min, 30 min, 1 h, 2 h, 3 h, 6 h, 12 h, 1 day, etc., or more abstract values such as immediately, soon, no latency bound. In the latter case, the UE 115-a may use a translation table to convert from the abstract values to concrete time windows. In some aspects, forwarding of the messages to destination device 215 is delayed by not more than the earliest deadline of all messages the UE 115-a has cached.

In another aspect, the cost metric may also be designed as time-dependent parameters. This may allow UE 115-a to capture the usage-specific nature of certain cellular data plans, for instance. In many of these plans, a certain monthly usage is covered by the base cost of the plan while additional charges apply per data transferred as soon as the plan-specific limit has been exceeded. In such scenarios, the cost metric may be held rather low as long as data usage is far below the monthly limit, and could be increased when the data usage is reaching or exceeded this monthly limit.

In some aspects, the cost metrics may also capture the particular charges applied by a specific network operator. A cellular operator supporting cellular access air interface as well as Wi-Fi offload, for instance, may charge for the usage of Wi-Fi. In this case, using the operator's Wi-Fi access may be less expensive than this operator's cellular access but it may still be more expensive than a free Wi-Fi-hotspot or a flat-rate access point which has already been paid for. In this case, each air-interface/network operator pair may be associated with a different cost metric.

In some aspects, the UE 115-a may select among third generation (3G), fourth generation (4G), advanced fifth generation (5G), and Wi-Fi air interfaces. UE 115-a may assign a preference to unlicensed air interfaces over licensed interfaces, in some examples. In other aspects, UE 115-a may select among multiple operators or access networks. In this case, UE 115-a may use the same physical interface to connect to these operators or access networks. In some aspects, UE 115-a may select among air-interface/operator pairs where the interface may apply to any cellular of Wi-Fi interfaces. In some examples, instead of a common broadband cellular interface, the UE 115-a may also select specific TOT interfaces. In some aspects, UE 115-a may further consider historical information associated with the UE's location when determining air interface availability for selection.

In some aspects, UE 115-a may further include resource usage, such as available battery or processing power, into the air interface selection process. In an example where battery power is low, UE 115-a may give priority to an air interface that provides lower battery consumption. In an example where other applications use a large fraction of processing capabilities, UE 115-a may hold off on message delivery until the deadline has been reached.

In some aspects, the periodic evaluation of air interfaces may use a timer or interrupts. In the case of a timer, the evaluation process may wake up after a time interval, perform an evaluation of the cost metric for each air interface, forward the message when appropriate, and return to a sleep or idle mode for a new time interval. In case of interrupts, the evaluation process may be triggered by other processes on the UE 115-a that run independently. The UE 115-a may evaluate change of state, e.g., an air interface becoming available, during the evaluation process.

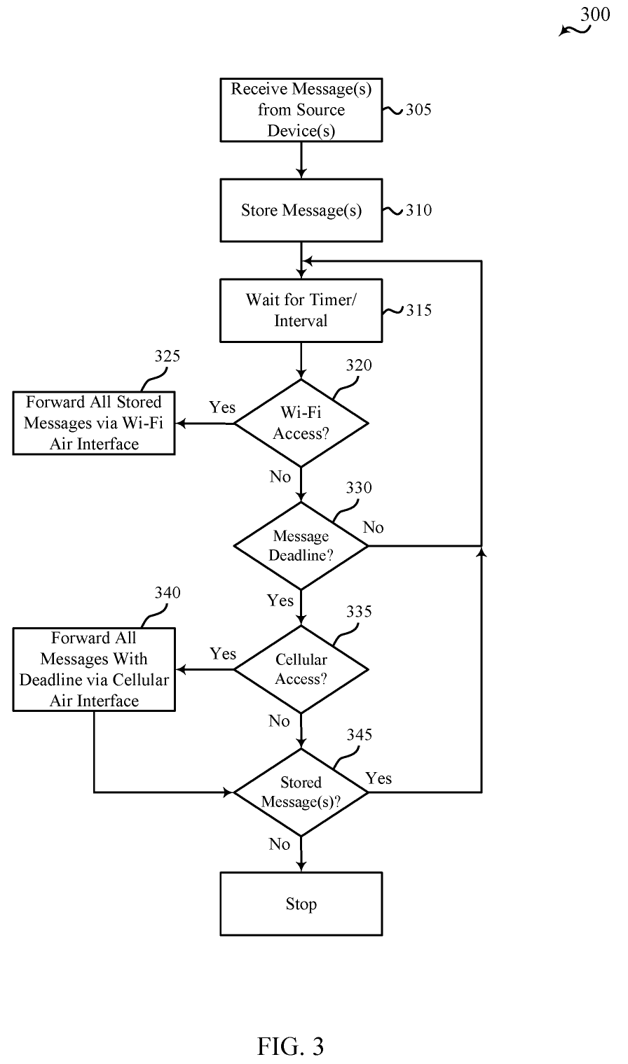

FIG. 3 shows a process flow 300 for network selection for relaying of delay-tolerant traffic in accordance with various aspects of the present disclosure. The operations of process flow 300 may be implemented by a device such as a UE 115 or its components as described with reference to FIGS. 1 and 2. In some examples, the UE 115 may execute a set of codes to control the functional elements of the device to perform the functions described below. Additionally or alternatively, the UE 115 may perform aspects of the functions described below using special-purpose hardware. Generally, process flow 300 illustrates an example where the air interface selection for message forwarding gives priority to a Wi-Fi air interface.

In the example process flow 300, the UE 115 may support a Wi-Fi and a cellular air interface for network traffic. The UE 115 may assign a cost metric value of C_wifi to the use of a Wi-Fi air interface for data delivery and a cost metric value of C_cell<C_wifi for the use of a cellular air interface. When the UE 115 has stored messages from a source device, UE 115 may periodically determine the availability of both air interfaces.

At 305, UE 115 may receive a message(s) from source device(s). The message may be or include delay tolerant traffic and the message may include a latency indicator. At 310, the UE 115 may store or cache the message to be forwarded at a later time. At 315, the UE 115 may wait for the timer or until an interrupt arrives to determine the cost metric for the air interfaces. The timer may be based on the evaluation process, as discussed above. An interrupt may be associated with a new message arrival, for example. The UE 115 may determine the delay-tolerance metric for the message based on the latency indicator. The UE 115 may identify a cost metric for each air interface. UE 115 may include other conditions such as UE 115 registration to a cellular network when determining the cost metric for each air interface.

At 320, UE 115 may determine whether a Wi-Fi access is available. For example, the UE 115 may determine availability of the Wi-Fi air interface by conducting signal strength measurements on beacon signals it receives. UE 115 may restrict the evaluation of Wi-Fi air interfaces to a subset of preconfigured service set identifiers (SSIDs) or to those that have no security requirements. UE 115 may also restrict the evaluation to Wi-Fi air interfaces it is or has previously associated with. If a Wi-Fi air interface is available, at 325 the UE 115 may forward stored messages via the Wi-Fi air interface. Thus, the UE 115 may give priority to Wi-Fi air interfaces over other air interfaces.

If no Wi-Fi air interface is available, at 330 the UE 115 may determine whether the message delivery deadline is within a threshold value, e.g., whether the delivery deadline has been reached or is approaching. If not, the process flow 300 may return to 315 where the UE 115 may wait until the next evaluation interval timer or interrupt. If the delivery deadline for one or more stored message has been reached or approaches, at 335 the UE 115 may determine whether there are any cellular air interfaces available. For example, the UE 115 may determine availability of the cellular interface by conducting a signal strength measurement on a cellular synchronization signal such as a primary synchronization signal/secondary synchronization signal (PSS/SSS) in LTE. If a cellular air interface is available, at 340 the UE may establish a connection via the cellular air interface and forward message(s) via the cellular interface. In some aspects, the UE 115 may only forward messages via the cellular air interfaces that the delivery deadline has been reached or is within a threshold.

If no cellular air interfaces are available, or once the UE 115 has forwarded the expiring messages, at 345 the UE 115 determines whether there are additional stored messages. If so, process flow 300 returns to 315 where the UE 115 may wait until the next evaluation interval timer or interrupt. Process flow 300 stops if there are no more stored messages to be forwarded.

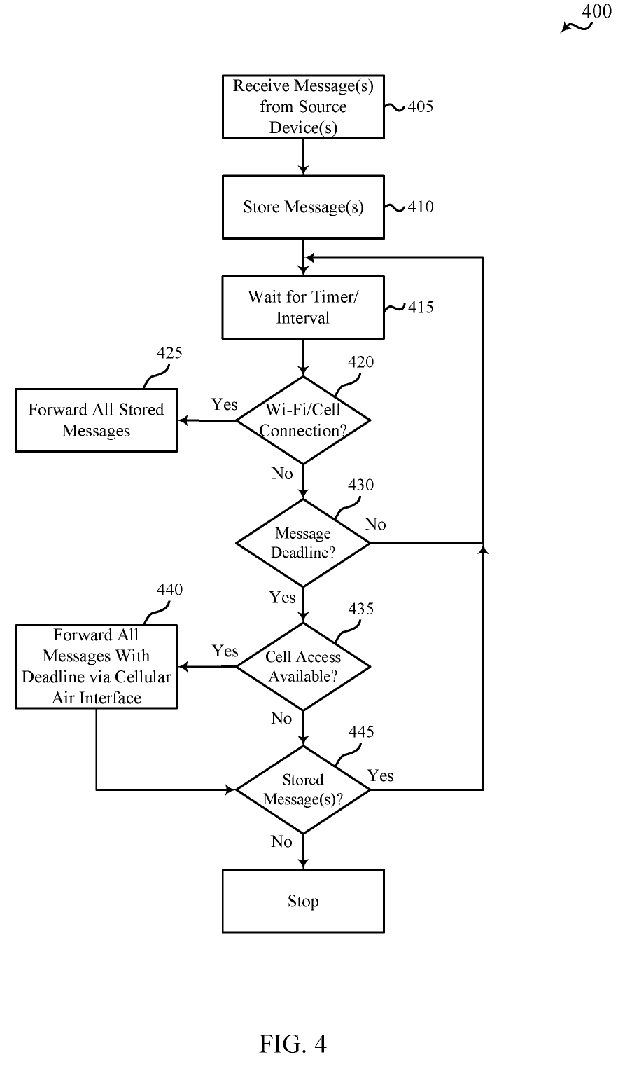

FIG. 4 shows a process flow 400 for network selection for relaying of delay-tolerant traffic in accordance with various aspects of the present disclosure. The operations of process flow 400 may be implemented by a device such as a UE 115 or its components as described with reference to FIGS. 1 and 2. In some examples, the UE 115 may execute a set of codes to control the functional elements of the device to perform the functions described below. Additionally or alternatively, the UE 115 may perform aspects of the functions described below using special-purpose hardware. Generally, process flow 400 illustrates an example where the air interface selection for message forwarding gives priority to an active connection on an air interface.

In the example process flow 400, the UE 115 may support a Wi-Fi and a cellular air interface for network traffic. The UE 115 may assigns a cost metric value of C_wifi to the use of a Wi-Fi air interface for data delivery and a cost metric value of C_cell<C_wifi for the use of a cellular air interface. When the UE 115 has stored messages from a source device, UE 115 may periodically determine the availability of both air interfaces.

At 405, UE 115 may receive a message(s) from source device(s). The message may be or include delay tolerant traffic and the message may include a latency indicator. At 410, the UE 115 may store or cache the message to be forwarded at a later time. At 415, the UE 115 may wait for the timer or until an interrupt arrives to determine the cost metric for the air interfaces. The timer may be based on the evaluation process, as discussed above. An interrupt may be associated with a new message arrival, for example. The UE 115 may determine the delay-tolerance metric for the message based on the latency indicator. The UE 115 may identify a cost metric for each air interface. UE 115 may include other conditions such as UE 115 registration to a cellular network and/or Wi-Fi network when determining the cost metric for each air interface.

At 420, UE 115 may determine whether there is an active connection via a cellular air interface or a Wi-Fi air interface. For example, the UE 115 may determine availability of the Wi-Fi air interface connection by conducting signal strength measurements on beacon signals it receives, by analyzing an association status for the Wi-Fi air interface, etc. The UE 115 may determine availability of the cellular air interface by conducting a signal strength measurement on a cellular synchronization signal such as a PSS/SSS in LTE, by determining a radio resource control (RRC) connection status of the cellular air interface, etc. If a Wi-Fi air interface or a cellular air interface is available, at 425 the UE 115 may forward stored messages via the air interface with the active connection. Thus, the UE 115 may give priority to an active connection on an air interfaces.

If no active connections are available, at 430 the UE 115 may determine whether the message delivery deadline is within a threshold value, e.g., whether the delivery deadline has been reached or is approaching. If not, the process flow 400 may return to 415 where the UE 115 may wait until the next evaluation interval timer or interrupt. If the delivery deadline for one or more stored message has been reached or approaches, at 435 the UE 115 may determine whether there are any cellular air interfaces available, e.g., by measuring a synchronization signal. If a cellular air interface is available, at 440 the UE may establish an active connection on the cellular air interface and forward message(s) via the cellular air interface. In some aspects, the UE 115 may only forward messages via the cellular air interfaces that the delivery deadline has been reached or is within a threshold level.

If no cellular air interfaces are available, or once the UE 115 has forwarded the expiring messages, at 445 the UE 115 determines whether there are additional stored messages. If so, process flow 400 returns to 415 where the UE 115 may wait until the next evaluation interval timer or interrupt. Process flow 400 stops if there are no more stored messages to be forwarded.

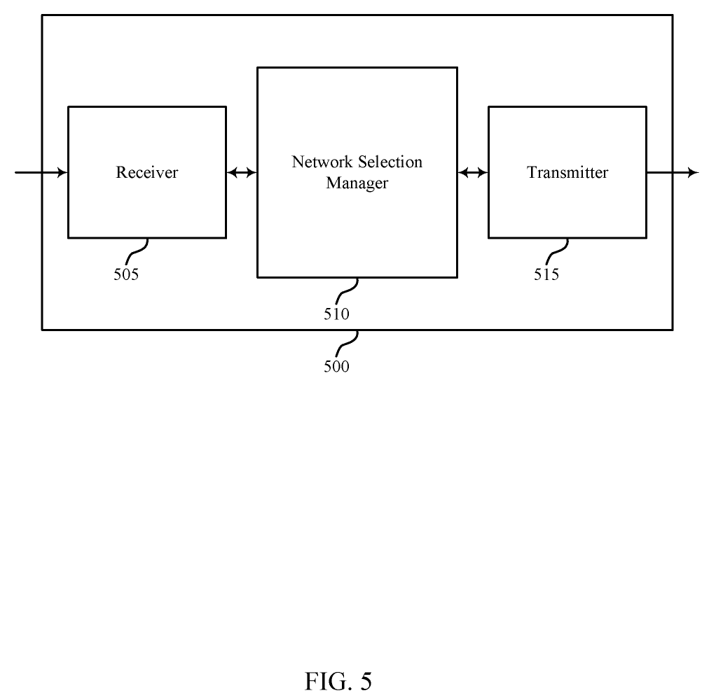

FIG. 5 shows a block diagram of a wireless device 500 that supports network selection for relaying of delay-tolerant traffic in accordance with various aspects of the present disclosure. Wireless device 500 may be an example of aspects of a UE 115 described with reference to FIGS. 1 through 4. Wireless device 500 may include a receiver 505, a network selection manager 510, and a transmitter 515. Wireless device 500 may also include a processor. Each of these components may be in communication with each other.

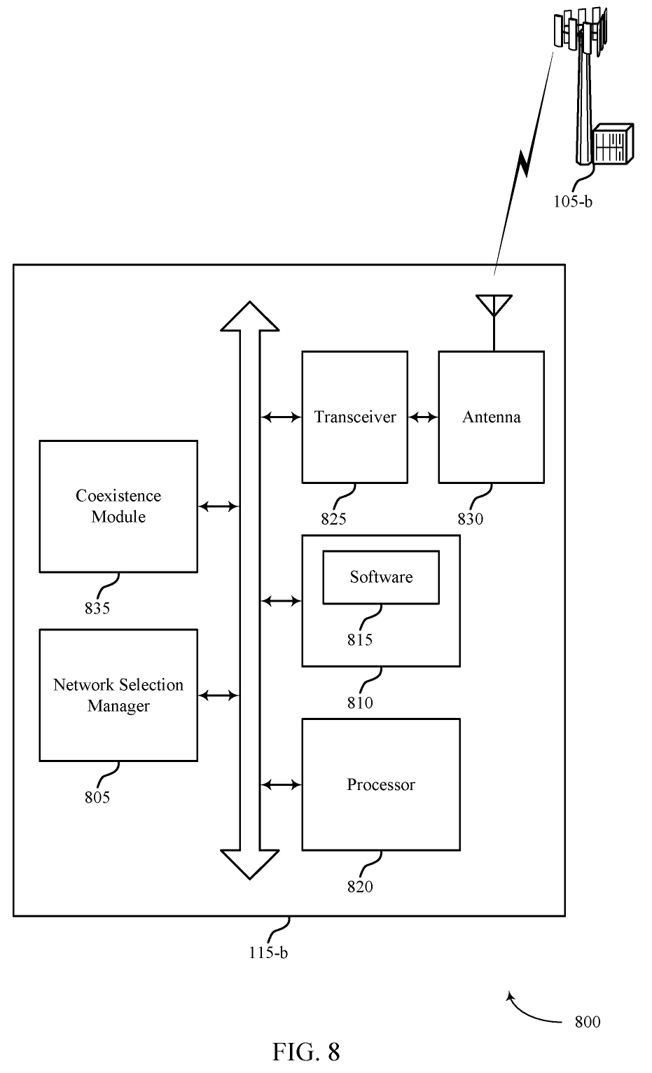

The receiver 505 may receive information such as packets, user data, or control information associated with various information channels (e.g., control channels, data channels, and information related to network selection for relaying of delay-tolerant traffic, etc.). Information may be passed on to other components of the device. The receiver 505 may be an example of aspects of the transceiver 825 described with reference to FIG. 8.

The network selection manager 510 may receive a message from a source device, the message including a latency indicator, identify a delay-tolerance metric associated with the message, the delay-tolerance metric based on the latency indicator, identify, for each air interface of a set of air interfaces, a cost metric associated with transmitting the message, select an air interface, from the set of air interfaces, based on the delay-tolerance metric and the cost metric, and transmit the message to a destination device via the selected air interface. The network selection manager 510 may also be an example of aspects of the network selection manager 805 described with reference to FIG. 8.

The transmitter 515 may transmit signals received from other components of wireless device 500. In some examples, the transmitter 515 may be collocated with a receiver in a transceiver module. For example, the transmitter 515 may be an example of aspects of the transceiver 825 described with reference to FIG. 8. The transmitter 515 may include a single antenna, or it may include a plurality of antennas.

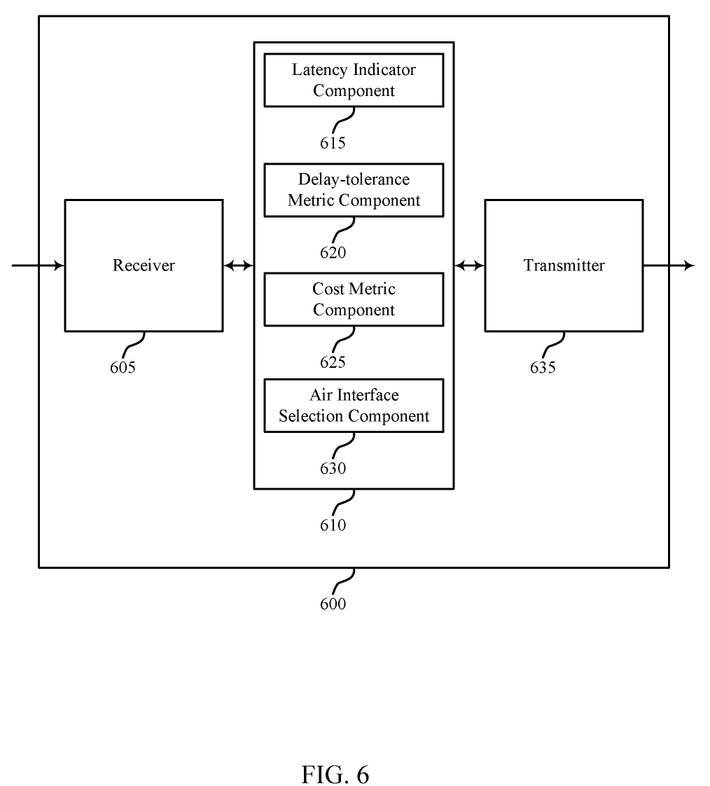

FIG. 6 shows a block diagram of a wireless device 600 that supports network selection for relaying of delay-tolerant traffic in accordance with various aspects of the present disclosure. Wireless device 600 may be an example of aspects of a wireless device 500 or a UE 115 described with reference to FIGS. 1 through 5. Wireless device 600 may include a receiver 605, a network selection manager 610 and a transmitter 635. Wireless device 600 may also include a processor. Each of these components may be in communication with each other.

The receiver 605 may receive information which may be passed on to other components of the device. The receiver 605 may also perform the functions described with reference to the receiver 505 of FIG. 5. The receiver 605 may be an example of aspects of the transceiver 825 described with reference to FIG. 8.

The network selection manager 610 may be an example of aspects of network selection manager 510 described with reference to FIG. 5. The network selection manager 610 may include a latency indicator component 615, a delay-tolerance metric component 620, a cost metric component 625 and an air interface selection component 630. The network selection manager 610 may be an example of aspects of the network selection manager 805 described with reference to FIG. 8.

The latency indicator component 615 may receive a message from a source device, the message including a latency indicator. In some cases, the source device includes at least one of a wearable device, a sensor device, or combinations thereof. In some cases, the source device includes at least one of an application layer associated with the relay device.

The delay-tolerance metric component 620 may identify a delay-tolerance metric associated with the message, the delay-tolerance metric may be based on the latency indicator. In some cases, the delay-tolerance metric is associated with at least one of a delivery deadline associated with the message, a delivery window associated with the message, a delivery priority associated with the message, or combinations thereof.

The cost metric component 625 may identify, for each air interface of a set of air interfaces, a cost metric associated with transmitting the message. In some cases, the cost metric is associated with at least one of a monetary cost associated with transmitting the message via the air interface, a data limit associated with the air interface, a communication channel quality associated with the air interface, a current connection to the air interface, a relay device resource utilization metric associated with transmitting the message via the air interface, or combinations thereof.

The air interface selection component 630 may select an air interface, from the set of air interfaces, based on the delay-tolerance metric and the cost metric, and transmit the message to a destination device via the selected air interface. In some cases, an air interface of the set of air interfaces includes at least one of a cellular RAT, or a Wi-Fi RAT, or a Bluetooth RAT, or a Bluetooth low energy RAT, or a D2D RAT. In some cases, transmitting the message via the selected air interface includes transmitting the message via a licensed RF spectrum band or an unlicensed RF spectrum band.

The transmitter 635 may transmit signals received from other components of wireless device 600. In some examples, the transmitter 635 may be collocated with a receiver in a transceiver module. For example, the transmitter 635 may be an example of aspects of the transceiver 825 described with reference to FIG. 8. The transmitter 635 may utilize a single antenna, or it may utilize a plurality of antennas.

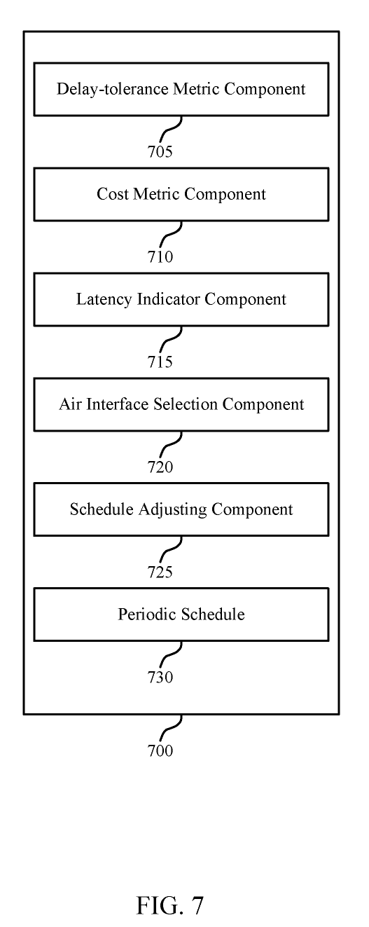

FIG. 7 shows a block diagram of a network selection manager 700 which may be an example of the corresponding component of wireless device 500 or wireless device 600. That is, network selection manager 700 may be an example of aspects of network selection manager 510 or network selection manager 610 described with reference to FIGS. 5 and 6. The network selection manager 700 may also be an example of aspects of the network selection manager 805 described with reference to FIG. 8.

The network selection manager 700 may include a delay-tolerance metric component 705, a cost metric component 710, a latency indicator component 715, an air interface selection component 720, a schedule adjusting component 725 and a periodic schedule 730. Each of these modules may communicate, directly or indirectly, with one another (e.g., via one or more buses).

The delay-tolerance metric component 705 may identify a delay-tolerance metric associated with the message, the delay-tolerance metric may be based on the latency indicator. The cost metric component 710 may identify, for each air interface of a set of air interfaces, a cost metric associated with transmitting the message.

The latency indicator component 715 may receive a message from a source device, the message including a latency indicator. The air interface selection component 720 may select an air interface, from the set of air interfaces, based on the delay-tolerance metric and the cost metrics, and transmit the message to a destination device via the selected air interface.

The schedule adjusting component 725 may adjust a periodic schedule based on the delay-tolerance metric indicating at least one of a delivery deadline associated with the message is within a predefined threshold, a remaining portion of a delivery window associated with the message is within a predefined threshold, a delivery priority associated with the message is above a threshold level, or combinations thereof. The periodic schedule 730 may determine a cost metric for each air interface according to a periodic schedule.

FIG. 8 shows a diagram of a system 800 including a device that supports network selection for relaying of delay-tolerant traffic in accordance with various aspects of the present disclosure. For example, system 800 may include UE 115-b, which may be an example of a wireless device 500, a wireless device 600, or a UE 115 as described with reference to FIGS. 1 through 7.

UE 115-b may also include network selection manager 805, memory 810, processor 820, transceiver 825, antenna 830 and coexistence module 835. Each of these modules may communicate, directly or indirectly, with one another (e.g., via one or more buses). The network selection manager 805 may be an example of a network selection manager as described with reference to FIGS. 5 through 7.

The memory 810 may include random access memory (RAM) and read only memory (ROM). The memory 810 may store computer-readable, computer-executable software including instructions that, when executed, cause the processor to perform various functions described herein (e.g., network selection for relaying of delay-tolerant traffic, etc.).

In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.)

The transceiver 825 may communicate bi-directionally, via one or more antennas, wired, or wireless links, with one or more networks, as described above. For example, the transceiver 825 may communicate bi-directionally with a base station 105-b or another UE 115. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions.

Coexistence module 835 may enable operations in a wireless environment comprising networks utilizing multiple RATs such as a WWAN and a WLAN.

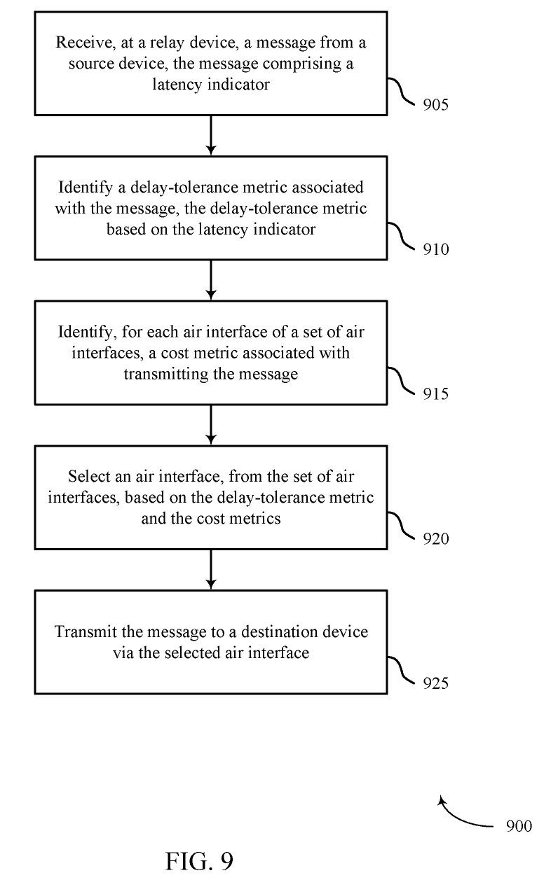

FIG. 9 shows a flowchart illustrating a method 900 for network selection for relaying of delay-tolerant traffic in accordance with various aspects of the present disclosure. The operations of method 900 may be implemented by a device such as a UE 115 or its components as described with reference to FIGS. 1 through 4. For example, the operations of method 900 may be performed by the network selection manager as described herein. In some examples, the UE 115 may execute a set of codes to control the functional elements of the device to perform the functions described below. Additionally or alternatively, the UE 115 may perform aspects the functions described below using special-purpose hardware.

At block 905, the UE 115 may receive a message from a source device, the message including a latency indicator as described above with reference to FIGS. 2 through 4. In certain examples, the operations of block 905 may be performed by the latency indicator component as described with reference to FIGS. 6 and 7.

At block 910, the UE 115 may identify a delay-tolerance metric associated with the message, the delay-tolerance metric based on the latency indicator as described above with reference to FIGS. 2 through 4. In certain examples, the operations of block 910 may be performed by the delay-tolerance metric component as described with reference to FIGS. 6 and 7.

At block 915, the UE 115 may identify, for each air interface of a set of air interfaces, a cost metric associated with transmitting the message as described above with reference to FIGS. 2 through 4. In certain examples, the operations of block 915 may be performed by the cost metric component as described with reference to FIGS. 6 and 7.

At block 920, the UE 115 may select an air interface, from the set of air interfaces, based on the delay-tolerance metric and the cost metrics as described above with reference to FIGS. 2 through 4. In certain examples, the operations of block 920 may be performed by the air interface selection component as described with reference to FIGS. 6 and 7.

At block 925, the UE 115 may transmit the message to a destination device via the selected air interface as described above with reference to FIGS. 2 through 4. In certain examples, the operations of block 925 may be performed by the air interface selection component as described with reference to FIGS. 6 and 7.

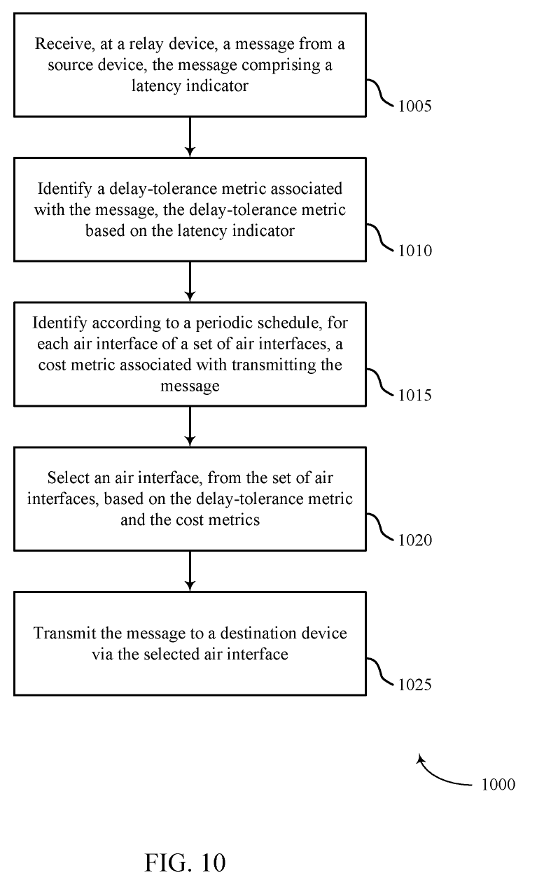

FIG. 10 shows a flowchart illustrating a method 1000 for network selection for relaying of delay-tolerant traffic in accordance with various aspects of the present disclosure. The operations of method 1000 may be implemented by a device such as a UE 115 or its components as described with reference to FIGS. 1 through 4. For example, the operations of method 1000 may be performed by the network selection manager as described herein. In some examples, the UE 115 may execute a set of codes to control the functional elements of the device to perform the functions described below. Additionally or alternatively, the UE 115 may perform aspects the functions described below using special-purpose hardware.

At block 1005, the UE 115 may receive a message from a source device, the message including a latency indicator as described above with reference to FIGS. 2 through 4. In certain examples, the operations of block 1005 may be performed by the latency indicator component as described with reference to FIGS. 6 and 7.

At block 1010, the UE 115 may identify a delay-tolerance metric associated with the message, the delay-tolerance metric based on the latency indicator as described above with reference to FIGS. 2 through 4. In some cases, the UE 115 may determine the cost metric for each air interface according to a periodic schedule. In certain examples, the operations of block 1010 may be performed by the delay-tolerance metric component as described with reference to FIGS. 6 and 7.

At block 1015, the UE 115 may identify, for each air interface of a set of air interfaces, a cost metric associated with transmitting the message as described above with reference to FIGS. 2 through 4. In certain examples, the operations of block 1015 may be performed by the cost metric component as described with reference to FIGS. 6 and 7.

At block 1020, the UE 115 may select an air interface, from the set of air interfaces, based on the delay-tolerance metric and the cost metrics as described above with reference to FIGS. 2 through 4. In certain examples, the operations of block 1020 may be performed by the air interface selection component as described with reference to FIGS. 6 and 7.

At block 1025, the UE 115 may transmit the message to a destination device via the selected air interface as described above with reference to FIGS. 2 through 4. In certain examples, the operations of block 1025 may be performed by the air interface selection component as described with reference to FIGS. 6 and 7.

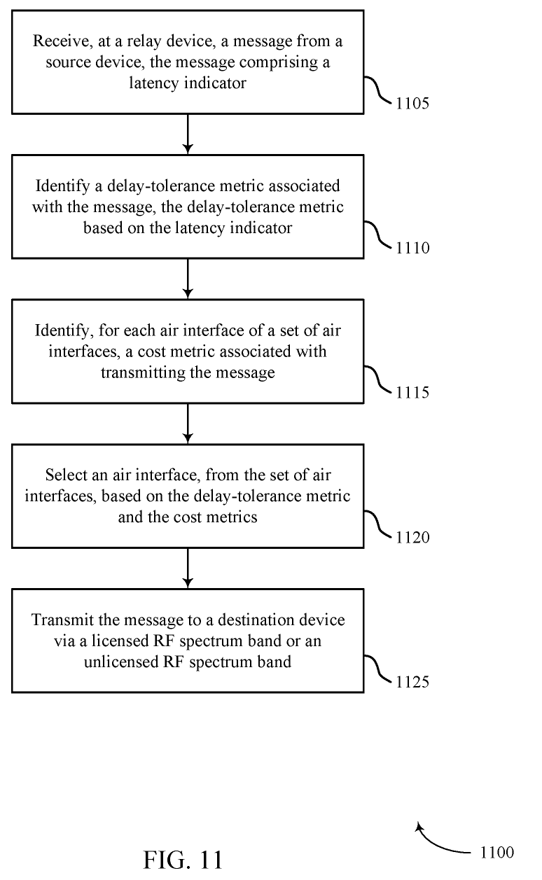

FIG. 11 shows a flowchart illustrating a method 1100 for network selection for relaying of delay-tolerant traffic in accordance with various aspects of the present disclosure. The operations of method 1100 may be implemented by a device such as a UE 115 or its components as described with reference to FIGS. 1 through 4. For example, the operations of method 1100 may be performed by the network selection manager as described herein. In some examples, the UE 115 may execute a set of codes to control the functional elements of the device to perform the functions described below. Additionally or alternatively, the UE 115 may perform aspects the functions described below using special-purpose hardware.

At block 1105, the UE 115 may receive a message from a source device, the message including a latency indicator as described above with reference to FIGS. 2 through 4. In certain examples, the operations of block 1105 may be performed by the latency indicator component as described with reference to FIGS. 6 and 7.

At block 1110, the UE 115 may identify a delay-tolerance metric associated with the message, the delay-tolerance metric based on the latency indicator as described above with reference to FIGS. 2 through 4. In certain examples, the operations of block 1110 may be performed by the delay-tolerance metric component as described with reference to FIGS. 6 and 7.

At block 1115, the UE 115 may identify, for each air interface of a set of air interfaces, a cost metric associated with transmitting the message as described above with reference to FIGS. 2 through 4. In certain examples, the operations of block 1115 may be performed by the cost metric component as described with reference to FIGS. 6 and 7.

At block 1120, the UE 115 may select an air interface, from the set of air interfaces, based on the delay-tolerance metric and the cost metrics as described above with reference to FIGS. 2 through 4. In certain examples, the operations of block 1120 may be performed by the air interface selection component as described with reference to FIGS. 6 and 7.

At block 1125, the UE 115 may transmit the message to a destination device via the selected air interface as described above with reference to FIGS. 2 through 4. In some cases, transmitting the message via the selected air interface includes transmitting the message via a licensed RF spectrum band or an unlicensed RF spectrum band. In certain examples, the operations of block 1125 may be performed by the air interface selection component as described with reference to FIGS. 6 and 7.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for network selection for relaying of delay-tolerant traffic.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical (physical) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for network selection for relaying of delay-tolerant traffic. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
receiving, at a relay device, a message from a source device, the message comprising a latency indicator;
identifying a delay-tolerance metric associated with the message, the delay-tolerance metric based at least in part on the latency indicator;
identifying, for each air interface of a set of air interfaces, a cost metric associated with transmitting the message;
selecting an air interface, from the set of air interfaces, based at least in part on the delay-tolerance metric and the cost metrics; and
transmitting the message to a destination device via the selected air interface.

2. The method of claim 1, further comprising:
determining the cost metric for each air interface according to a periodic schedule.

3. The method of claim 2, further comprising:
adjusting the periodic schedule based at least in part on the delay-tolerance metric indicating at least one of a delivery deadline associated with the message is within a predefined threshold, a remaining portion of a delivery window associated with the message is within a predefined threshold, a delivery priority associated with the message is above a threshold level, or combinations thereof.

4. The method of claim 1, wherein the delay-tolerance metric is associated with at least one of a delivery deadline associated with the message, a delivery window associated with the message, a delivery priority associated with the message, or combinations thereof.

5. The method of claim 1, wherein the cost metric is associated with at least one of a monetary cost associated with transmitting the message via the air interface, a data limit associated with the air interface, a communication channel quality associated with the air interface, a current connection to the air interface, a relay device resource utilization metric associated with transmitting the message via the air interface, or combinations thereof.

6. The method of claim 1, wherein an air interface of the set of air interfaces comprises at least one of a cellular radio access technology (RAT), or a Wi-Fi RAT, or a Bluetooth RAT, or a Bluetooth low energy RAT, or a device-to-device (D2D) RAT.

7. The method of claim 1, wherein transmitting the message via the selected air interface comprises: transmitting the message via a licensed radio frequency (RF) spectrum band or an unlicensed RF spectrum band.

8. The method of claim 1, wherein the source device comprises at least one of a wearable device, a sensor device, or combinations thereof.

9. The method of claim 1, wherein the source device comprises at least one of an application layer associated with the relay device.

10. An apparatus for wireless communication comprising:
means for receiving, at a relay device, a message from a source device, the message comprising a latency indicator;
means for identifying a delay-tolerance metric associated with the message, the delay-tolerance metric based at least in part on the latency indicator;
means for identifying, for each air interface of a set of air interfaces, a cost metric associated with transmitting the message;
means for selecting an air interface, from the set of air interfaces, based at least in part on the delay-tolerance metric and the cost metrics; and
means for transmitting the message to a destination device via the selected air interface.

11. The apparatus of claim 10, further comprising:
means for determining the cost metric for each air interface according to a periodic schedule.

12. The apparatus of claim 11, further comprising:
means for adjusting the periodic schedule based at least in part on the delay-tolerance metric indicating at least one of a delivery deadline associated with the message is within a predefined threshold, a remaining portion of a delivery window associated with the message is within a predefined threshold, a delivery priority associated with the message is above a threshold level, or combinations thereof.

13. The apparatus of claim 10, wherein the delay-tolerance metric is associated with at least one of a delivery deadline associated with the message, a delivery window associated with the message, a delivery priority associated with the message, or combinations thereof.

14. The apparatus of claim 10, wherein the cost metric is associated with at least one of a monetary cost associated with transmitting the message via the air interface, a data limit associated with the air interface, a communication channel quality associated with the air interface, a current connection to the air interface, a relay device resource utilization metric associated with transmitting the message via the air interface, or combinations thereof.

15. The apparatus of claim 10, wherein an air interface of the set of air interfaces comprises at least one of a cellular radio access technology (RAT), or a Wi-Fi RAT, or a Bluetooth RAT, or a Bluetooth low energy RAT, or a device-to-device (D2D) RAT.

16. The apparatus of claim 10, wherein transmitting the message via the selected air interface comprises: transmitting the message via a licensed radio frequency (RF) spectrum band or an unlicensed RF spectrum band.

17. The apparatus of claim 10, wherein the source device comprises at least one of a wearable device, a sensor device, or combinations thereof.

18. The apparatus of claim 10, wherein the source device comprises at least one of an application layer associated with the relay device.

19. An apparatus for wireless communication, comprising:
a processor;
memory in electronic communication with the processor; and
instructions stored in the memory and operable, when executed by the processor, to cause the apparatus to:
receive, at a relay device, a message from a source device, the message comprising a latency indicator;
identify a delay-tolerance metric associated with the message, the delay-tolerance metric based at least in part on the latency indicator;
identify, for each air interface of a set of air interfaces, a cost metric associated with transmitting the message;
select an air interface, from the set of air interfaces, based at least in part on the delay-tolerance metric and the cost metrics; and
transmit the message to a destination device via the selected air interface.

20. The apparatus of claim 19, wherein the instructions are operable to cause the processor to:
determine the cost metric for each air interface according to a periodic schedule.

21. The apparatus of claim 20, wherein the instructions are operable to cause the processor to:
adjust the periodic schedule based at least in part on the delay-tolerance metric indicating at least one of a delivery deadline associated with the message is within a predefined threshold, a remaining portion of a delivery window associated with the message is within a predefined threshold, a delivery priority associated with the message is above a threshold level, or combinations thereof.

22. The apparatus of claim 19, wherein the delay-tolerance metric is associated with at least one of a delivery deadline associated with the message, a delivery window associated with the message, a delivery priority associated with the message, or combinations thereof.

23. The apparatus of claim 19, wherein the cost metric is associated with at least one of a monetary cost associated with transmitting the message via the air interface, a data limit associated with the air interface, a communication channel quality associated with the air interface, a current connection to the air interface, a relay device resource utilization metric associated with transmitting the message via the air interface, or combinations thereof.

24. The apparatus of claim 19, wherein an air interface of the set of air interfaces comprises at least one of a cellular radio access technology (RAT), or a Wi-Fi RAT, or a Bluetooth RAT, or a Bluetooth low energy RAT, or a device-to-device (D2D) RAT.

25. The apparatus of claim 19, wherein transmitting the message via the selected air interface comprises: transmitting the message via a licensed radio frequency (RF) spectrum band or an unlicensed RF spectrum band.

26. The apparatus of claim 19, wherein the source device comprises at least one of a wearable device, a sensor device, or combinations thereof.

27. The apparatus of claim 19, wherein the source device comprises at least one of an application layer associated with the relay device.

28. A non-transitory computer-readable medium storing code for wireless communication, the code comprising instructions executable to:
receive, at a relay device, a message from a source device, the message comprising a latency indicator;
identify a delay-tolerance metric associated with the message, the delay-tolerance metric based at least in part on the latency indicator;
identify, for each air interface of a set of air interfaces, a cost metric associated with transmitting the message;
select an air interface, from the set of air interfaces, based at least in part on the delay-tolerance metric and the cost metrics; and
transmit the message to a destination device via the selected air interface.

29. The non-transitory computer-readable medium of claim 28, wherein the instructions are executable to:
determine the cost metric for each air interface according to a periodic schedule.

30. The non-transitory computer-readable medium of claim 29, wherein the instructions are executable to:
adjust the periodic schedule based at least in part on the delay-tolerance metric indicating at least one of a delivery deadline associated with the message is within a predefined threshold, a remaining portion of a delivery window associated with the message is within a predefined threshold, a delivery priority associated with the message is above a threshold level, or combinations thereof.
